(19) United States
(12) Patent Application Publication
(10) Pub. No.: US 2026/0231277 A1
(43) Pub. Date: Aug. 6, 2026

(54) METHOD AND APPARATUS FOR RELEASING CONNECTION OF REPEATER NODE FROM ACCESS NODE

(71) Applicant: Samsung Electronics Co., Ltd., Suwon-si, Gyeonggi-do (KR)

(72) Inventors: Jonas SEDIN, Staines (GB); Milos TESANOVIC, Staines (GB)

(21) Appl. No.: 19/151,857

(22) PCT Filed: Feb. 16, 2024
(86) PCT No.: PCT/KR2024/095274

§ 371 Date: Jul. 29, 2025

(30) Foreign Application Priority Data
Feb. 16, 2023 (GB) 2302215.5

(51) Int. Cl. H04W 76/27; H04W 76/30; H04W 84/04

(52) U.S. Cl. CPC H04W 76/27; H04W 76/30; H04W 84/047

(57) ABSTRACT

The disclosure relates to a 5G or 6G communication system for supporting a higher data transmission rate. A method, for a repeater node (e.g. an NCR) capable of performing a forwarding function (e.g. NCR-Fwd function) in a network. The method comprises: receiving a release message (e.g. an RRCRelease message) for instructing the repeater node to release a connection (e.g. a control link of the repeater node, or a connection with an MT of the repeater node) with an access node (e.g. a base station); and releasing the connection in response to receiving the release message. The method further comprises configuring a state of the repeater node based on the received release message. The release message may include configuration information, and the method may further comprise configuring the state of the repeater node based on the configuration information.

### TECHNICAL FIELD

Certain examples of the present disclosure provide one or more techniques for releasing a connection of a repeater node from an access node in a network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to a wireless communication system and, more specifically, the present disclosure relates releasing a connection of a Network-Controlled Repeater (NCR) from an access node, such as a Distributed Unit (DU) of a base station (gNB) or Integrated Access and Backhaul (IAB) node, in a 3^{rd} Generation Partnership Project (3GPP) 5^{th} Generation (5G) New Radio (NR) network.

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

### Solution to Problem

According to one aspect of the present disclosure, a method performed by a terminal is provided. The method may include receiving, from a base station, a message for a radio resource control (RRC) release, performing a transition of an RRC state of the terminal from an RRC connected state to an RRC idle state, based on the message for the RRC release, and configuring a state of a network-controlled repeater (NCR) forward (NCR-fwd) as a forwarding-off state based on the message for the RRC release, in case that the terminal comprises an NCR mobile termination (MT).

According to another aspect of the present disclosure, a method performed by a base station is further provided. The method may include transmitting, to a terminal, a message for a radio resource control (RRC) release, wherein a transition of an RRC state of the terminal is performed from an RRC connected state to an RRC idle state, based on the message for the RRC release, and wherein a state of a network-controlled repeater (NCR) forward (NCR-fwd) is configured as a forwarding-off state based on the message for the RRC release, in case that the terminal comprises an NCR mobile termination (MT).

According to another aspect of the present disclosure, a terminal is further provided. The terminal may include a transceiver; and at least one processor is configured to receive, from a base station via the transceiver, a message for a radio resource control (RRC) release,
perform a transition of an RRC state of the terminal from an RRC connected state to an RRC idle state, based on the message for the RRC release, and configure a state of a network-controlled repeater (NCR) forward (NCR-fwd) as a forwarding-off state based on the message for the RRC release, in case that the terminal comprises an NCR mobile termination (MT).

According to another aspect of the present disclosure, a base station is further provided. The base station may include a transceiver; and at least one processor is configured to transmit, to a terminal via the transceiver, a message for a radio resource control (RRC) release, wherein a transition of an RRC state of the terminal is performed from an RRC connected state to an RRC idle state, based on the message for the RRC release, and wherein a state of a network-controlled repeater (NCR) forward (NCR-fwd) is configured as a forwarding-off state based on the message for the RRC release, in case that the terminal comprises an NCR mobile termination (MT).

The present invention is defined in the independent claims. Advantageous features are defined in the dependent claims.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

### Advantageous Effects of Invention

According to an embodiment of present disclosure, a connection of a Network-Controlled Repeater (NCR) can be efficiently released.

### BRIEF DESCRIPTION OF DRAWINGS

FIG. 1 illustrates an exemplary NCR communication architecture;

FIG. 2 is a reproduction of FIG. 5.2.2-1 from 3GPP TS 38.304, V17.2.0;

FIG. 3 illustrates an exemplary RRC release procedure;

FIG. 4 illustrates an exemplary procedure for configuring, through an RRC release message, an NCR to turn NCR-Fwd state OFF;

FIG. 5 illustrates an exemplary procedure for configuring, through an RRC Release message, a time for an NCR to remain in idle mode before re-connecting to a gNB;

FIG. 6 illustrates an exemplary procedure for delaying an RRC release procedure for a certain period of time after receiving an RRC Release message to reduce a chance of state mismatch between the NCR and gNB;

FIG. 7 illustrates an exemplary procedure for releasing an NCR device without a request to AMF;

FIG. 8 illustrates an exemplary procedure for allowing a second gNB to request a first gNB to release an NCR; and

FIG. 9 is a block diagram of an exemplary network entity that may be used in certain examples of the present disclosure.

### MODE FOR THE INVENTION

### Overview of Network-Controlled Repeater (NCR)

In order to provide enhanced network coverage, a variety of different types of network nodes have been developed. For example, a Radio Frequency (RF) repeater may be deployed to amplify and forward any signal that it receives to supplement coverage provided by a regular cell. An enhanced type of repeater node, called a Network-Controlled Repeater (NCR), is currently under development and is a Release 18 Study Item/Work Item (3GPP RP-213700).

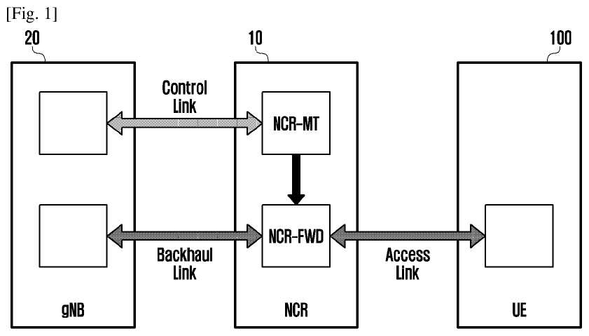

FIG. 1 illustrates the network architecture of NCR communication. As shown, the NCR 10 comprises NCR-Mobile Termination (MT) and NCR-Forward (FWD) functions/entities. NCR-FWD receives and forwards signals from gNB 20 to User Equipment (UE) 100 via a backhaul link between gNB 20 and NCR-FWD, and an access link between NCR-FWD and UE 100. NCR-MT receives control signals from gNB 20 via a control link, and configures and controls NCR-FWD based on the control signals. Once configured, NCR-FWD provides an amplify-and-forward function that is transparent to the UE 100. Accordingly, gNB 20 may communicate with UE 100 directly or through the NCR 10.

To enable easy deployment of NCR nodes, an NCR is configured to be transparent to a UE whether it is communicating through an NCR or not. For example, when an NCR is deployed, to make the NCR transparent to the UE for a random access procedure, the gNB may allocate a set of Synchronization Signal Block (SSB) indices to the NCR when the NCR registers to the network (while other SSB indices remain with gNB), for example as described in 3GPP R1-2203741, Section 5. The UE may then perform the random access procedure via SSBs transmitted via SSB indices allocated to the NCR as though the random access procedure was performed via the gNB.

The NCR-MT part of the NCR is expected to function almost like a normal UE, meaning that the NCR configurations are signalled similar to a normal UE. This means that NCR-MT will have a full protocol stack, but it is expected that some functionality that is normally used by a UE may not be applicable and will not be implemented by the NCR-MT and/or configured by the network.

Overview of Radio Resource Control (RRC) idle/inactive idle mode procedures

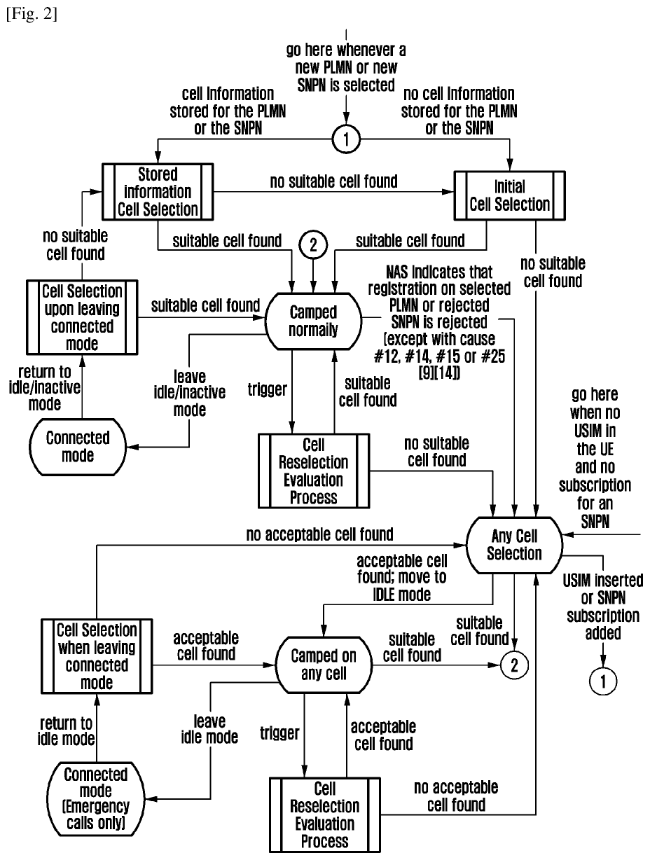

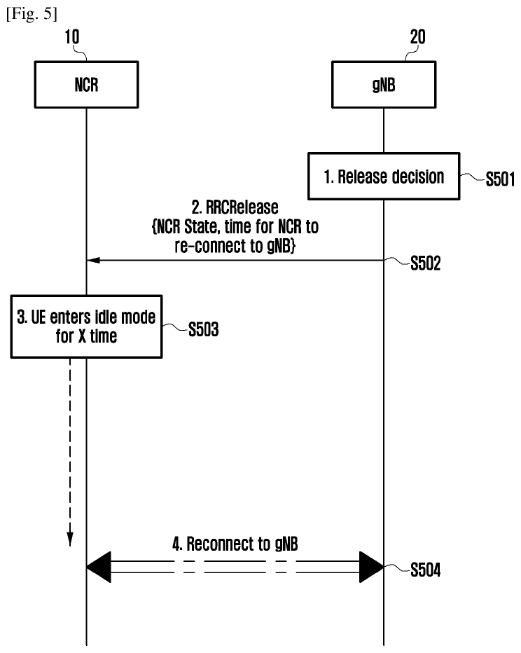

The procedures for a UE in RRC idle mode are illustrated in FIG. 2 (which is FIG. 5.2.2-1 from 3GPP TS 38.304, V17.2.0).

The idle mode procedures include:
Public Land Mobile Network (PLMN) selection
The UE scans and reports detected PLMNs to Non Access Stratum (NAS). A PLMN is reported as a high quality PLMN if the measured Reference Signal Received Power (RSRP) value is greater than-110 dBm.
Cell selection
UE selects an (possibly initial) cell based on two criteria known as the cell selection criteria. The UE selects a cell that fulfils the criteria, but if multiple cells satisfy the criteria, it is not specified which of those cells the UE shall select. The criteria are based on the received power level as well as the quality of the signal, which are in turn based on signalled thresholds and measurements.
Cell reselection
Cell reselection is performed for the UE to camp on the most suitable cell. In addition to the cell selection criteria, the UE also ranks different cells of the same priority to choose the best cell. The UE also measures on different frequencies that have either higher or lower priority, which ensures that the UE always camps on the best cell with the highest priority.
Location registration and Radio Access Network (RAN) Area Registration
Tracking Area registration—The UE reports the tracking area information to NAS. If a UE camps on a new tracking area, a Tracking Area Update (TAU) is triggered. This can also be done periodically.
RAN Area Registration—The UE performs a RAN-based notification area update when the UE camps on a new cell that does not belong to the current RAN Notification Area (RNA). This can also be done periodically.

### Overview of RRC Inactive Procedures

RRC inactive is a state in which the UE may move faster to connected mode compared to RRC idle, for example to perform data transmission. The transition to connected mode is faster because the gNB maintains the UE context when the UE is in inactive mode. This means that the UE does not need to re-initiate security and the UE does not need to be fully re-configured whenever the UE re-connects.

This mechanism is enabled by the UE being configured with an RNA, in which the UE may camp without having to notify RAN. If the UE detects another RNA, the UE performs RNA Update procedures where the UE performs random access and includes the value rna-Update in the field resumeCause in message RRCResumeRequest.

### Overview of RRC Release

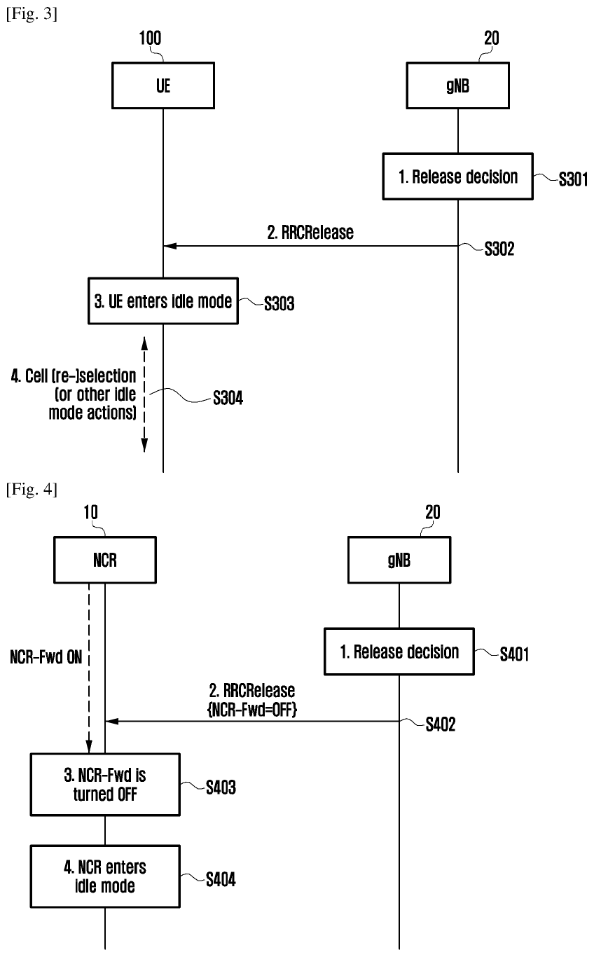

One way to enter RRC idle or RRC inactive mode is by the network releasing the UE through the RRC release procedures. The RRC release procedures are initiated when the UE receives an RRCRelease message from the gNB. This procedure is illustrated in FIG. 3.

Referring to FIG. 3, in a first operation S301, a gNB 20 decides that a connection with a UE 100 should be released. In a second operation S302, the gNB 20 transmits a message (RRCRelease message) to the UE 100 in response to the release decision. In a third operation, S303, the UE 100 enters idle mode in response to receiving the message. In a fourth operation, S304, the UE 100 performs cell selection, cell reselection and/or any other suitable idle mode operations.

The release decision in operation S301, triggering transmission of the RRCRelease message from the gNB 20 to the UE 100, may be made by the gNB 20, or may in turn be triggered by the Access and Mobility management Function (AMF). For example, this may be done for one or more of the following reasons:
Load balancing
Re-direction (both in RRC idle and RRC inactive) to other frequencies or Radio Access Technologies (RATs)
UE context release triggered by the AMF (Core Network (CN))
Suspend indication to send the UE to RRC inactive
Failure to retrieve UE context when UE resumes RRC connection from RRC inactive

The RRCRelease message may include one or more of the following information elements, for example:
redirectedCarrierInfo—Information on carriers to re-direct to, which may be inter or intra-RAT frequencies.
cellReselectionPriorities—Cell reselection priorities. These may be specifically configured for the UE in the RRCRelease message.
suspendConfig—Configuration for RRC inactive.
deprioritisationReq
waitTime—Waiting time before the UE starts performing cell reselection to find a new cell.
measIdleConfig—Measurement configuration for idle mode. This is used to measure and store measurement information to be reported to the network when reconnecting.
sdtConfig—Configurations for Short Data Transmissions (SDT). This allows UE to send a usually smaller amount of data in RRC inactive mode.
srs-PosRRC—Inactive-Sounding Reference Signal (SRS) configuration to be used for RRC inactive positioning.

The RRCRelease message may include one or more of the following timers, for example:
waitTime (T302)—Defining how long to bar the UE from attempting to access.
T320-Defining how long the cell configured cell reselection priorities shall be active
T380

When a UE receives the RRCRelease message, the specification allows for some time before performing the RRCRelease procedures. This is so that the RRCRelease message may be properly acknowledged to ensure that there is no state mismatch between gNB and UE. If this wait time is not applied after receiving the RRCRelease message, the gNB may not know whether the RRCRelease message has been received or not. The time before performing the RRCRelease procedures is 60 ms in 5G NR, 1.25 seconds in Long Term Evolution Machine Type Communication (LTE-M), and 10 seconds in Narrowband (NB)-Internet of Things (IoT). The RRCRelease procedures may be performed earlier if the RRCRelease message is successfully acknowledged.

This can be seen in the following part of the specification as a table 1:

TABLE 1

| | ------------------------- 3GPP TS 38.331 V17.2.0 ------------------------- |
|---|---|
| 5.3.8.3 | Reception of the RRCRelease by the UE |

The UE shall:

| 1> | delay the following actions defined in this clause 60 ms from the moment the RRCRelease message was | |
|---|---|---|
| | received or optionally when lower layers indicate that the receipt of the RRCRelease message has been | |
| | successfully acknowledged, whichever is earlier; | |
| 1> | stop timer T380, if running; | |
| 1> | stop timer T320, if running; | |
| 1> | if timer T316 is running; | |
| | 2> | stop timer T316; |
| | 2> | clear the information included in VarRLF-Report, if any; |

| | |
|---|---|
| 1> | stop timer T350, if running; |

...
------------------------- 3GPP TS 38.331 V17.2.0 -------------------------

The above information is presented as background information only to assist with an understanding of the present disclosure. No determination has been made, and no assertion is made, as to whether any of the above might be applicable as prior art with regard to the present invention.

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide one or more techniques for releasing a connection of a repeater node from an access node in a network. For example, certain examples of the present disclosure provide one or more techniques for releasing a connection of a NCR from an access node, such as a DU of a gNB or IAB node (or other type of relay node), in a 3GPP 5G NR network. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a base station or the like (e.g. eNB, gNB, NB, RAN node, access point, wireless point, transmission/reception point, central unit, distributed unit, radio unit, remote radio head, etc.) in the examples herein may be applied to any other suitable type of entity performing RAN functions, the functionality of an NCR or the like in the examples herein may be applied to any other suitable type of entity performing a repeater function, and the functionality of a UE or the like (e.g. electronic device, user device, mobile station, subscriber station, customer premises equipment, terminal, remote terminal, wireless terminal, vehicle terminal, etc.) in the examples herein may be applied to any other suitable type of device.

The skilled person will appreciate that the various examples disclosed herein may be implemented using existing messages (e.g. RRC messages, such as RRC Release) or any other suitable messages. The skilled person will appreciate that the names of messages may vary across different RATs, for example NR and LTE (Evolved Universal Terrestrial Radio Access Network (E-UTRAN)). For example, in 5G NR the release procedures are started by the RRCRelease message, whereas in E-UTRAN the corresponding name is RRCConnectionRelease. The skilled person will appreciate that examples disclosed herein referring to message names in one particular RAT (e.g. E-UTRAN) are not limited to that RAT, but may be applied to other RATs (e.g. NR).

The skilled person will appreciate that the various techniques disclosed herein may be applied to gNB and NG-RAN cases, and all related RRC signalling and/or messages, and to X2, Xn, S1, and Next Generation (NG) signalling and messages, and/or related network entities (e.g. Mobility Management Entity (MME), AMF, other).

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.

At least the following problem exist in view of the related art.

In the RAN2 #120 meeting, the following was agreed [RAN2 #120 meeting report (Future contribution R2-2300002)] with emphasis added:

### On NCR-Fwd ON/OFF:

When NCR-MT is in RRC_CONNECTED mode, the NCR-Fwd can be ON or OFF following the side control information received from the gNB.
After NCR-MT enters RRC_INACTIVE mode, the NCR-Fwd can be ON or OFF following the last configuration received from the gNB.
Release to RRC-IDLE is FFS.

When releasing an NCR, the purpose of the release may be different compared to releasing a UE. For example, in certain cases NCR may be released (i) when NCR-Fwd is being, or is about to be, switched OFF, and/or (ii) when the NCR-Fwd is kept in an ON state and NCR-Fwd operating parameters already configured are not expected to change for the foreseeable future (for example, if there is no need for Medium Access Control (MAC) Control Element (CE) signalling, RRC signalling, and/or Operations, Administration and Maintenance (OAM)).

Accordingly, what is desired are techniques to ensure that the NCR is released in a manner that is consistent with NCR operation. Certain examples of the present disclosure provide one or more techniques to allow an access node to release a repeater node.

The skilled will appreciate that the techniques disclosed herein may be applied to any suitable type of access node, such as a gNB (e.g. a NG-RAN gNB or a Donor gNB) or an IAB node. The skilled person will also appreciate that the techniques disclosed herein may be applied to any suitable type of repeater node, such as an NCR. In the case that the techniques disclosed herein are applied to an NCR-MTs in E-UTRA NR Dual Connectivity (EN-DC), certain operations may be performed over E-UTRAN, where the RRC messages may have different names to those used in the examples disclosed herein. For example, RRCRelease (in NR) or RRCConnectionRelease (in Evolved Universal Terrestrial Radio Access (E-UTRA)) may be used to convey information. The message names used in the examples disclosed herein should not be interpreted to mean that the techniques disclosed herein are limited to 5G NR or 5G NR Stand-Alone (SA).

In the present disclosure, the meaning of an NCR-Fwd being in an “ON”/“OFF” state may be defined in a number of ways according to the situation and/or implementation. For example, NCR-Fwd may be considered to be turned “OFF” if the NCR does not forward anything. In another example, NCR-Fwd may be considered to be turned “OFF” if the NCR does not forward anything and, additionally, any state or configuration related to the NCR is turned off. In one example, the NCR may be configured with beam information that informs the NCR-Fwd function at what times, and in which beam of the NCR, a slot shall be forwarded. In this case, when NCR-Fwd is turned “OFF”, this may mean that (i) the NCR-Fwd function does not continue to forward anything, (ii) the forwarding configuration is discarded, and/or (iii) a default forwarding configuration is applied. The skilled person will appreciate that the present disclosure is not limited to these examples.

Certain examples of the present disclosure provide a method, for a repeater node (e.g. an NCR) capable of performing a forwarding function (e.g. NCR-Fwd function) in a network, the method comprising: receiving a release message (e.g. an RRCRelease message) for instructing the repeater node to release a connection (e.g. a control link of the repeater node, or a connection with an MT of the repeater node) with an access node (e.g. a base station); and releasing the connection in response to receiving the release message, wherein the method further comprises configuring a state of the repeater node based on the received release message.

In certain examples, the state of the repeater node may comprise a forwarding state (e.g. a forwarding state of the forwarding entity/forwarding function of the repeater node) (e.g. a forwarding-on state, or a forwarding-off state).

In certain examples, the method may further comprise entering (e.g. by the MT part of the repeater node) an idle mode or an inactive mode in response to receiving the release message (e.g. after configuring the state of the repeater node).

In certain examples, the release message may include configuration information, and the method may further comprise configuring the state of the repeater node based on the configuration information.

In certain examples, the configuration information may be included in a MAC CE.

In certain examples, the configuration information may comprise: an indication to configure the repeater node to a first state (e.g. a forwarding-on state), or an indication to configure the repeater node to a second state (e.g. a forwarding-off state).

In certain examples, the configuration information may comprise one or more configuration parameters to apply when the repeater node is configured to a certain state (e.g. a first state or a second state).

In certain examples, the configuration information may be used to: configure which beam(s) the repeater node shall forward data on; and/or configure UL beams only, configure DL beams only, or configure both UL and DL beams.

In certain examples, the configuration information may comprise first time information indicating a time period that a certain configuration (e.g. a configured state and/or one or more configuration parameters) should be maintained.

In certain examples, the configuration information may comprise second time information indicating a time period that the idle mode or inactive mode should be maintained before reconnecting to the access node (e.g. base station) or connecting to another access node (e.g. another base station).

In certain examples, the method may further comprise configuring a forwarding state of the repeater node to a predefined state (e.g. a forwarding-on state, or forwarding-off state) in response to receiving the release message (e.g. if the release message does not include configuration information indicating a specific forwarding state).

In certain examples, the method may further comprise performing an acknowledgement procedure (e.g. transmitting a first acknowledgement message to the access node in response to receiving the release message, and optionally receiving a second acknowledgement message from the access node in response to transmitting the first acknowledgement message).

In certain examples, configuring the state of the repeater node may be delayed at least until completion of the acknowledgement procedure.

In certain examples, configuring the state of the repeater node may be delayed at least until the earlier of: (i) completion of the acknowledgement procedure, and (ii) a certain time period (e.g. a certain time period greater than 60 ms, for example 1 second) after receipt of the release message.

In certain examples, configuring the state of the repeater node based on the received release message may comprise, if a certain condition is satisfied and the repeater node is in a certain first state (e.g. a forward-on state), transitioning to a certain second state (e.g. a forward-off state).

In certain examples, the certain condition may be based on one or more of: a quality of coverage provided by the repeater node; a power level of the repeater node; an overheating condition of the repeater node; whether a current time falls within a certain predetermined time period (e.g. night time); a level of traffic handled by the repeater node; types of UEs served by a cell corresponding to the access node (e.g. base station); and a level of interference caused by the repeater node.

Certain examples of the present disclosure provide a method, for a network entity in a network, the method comprising: receiving a release message (e.g. an RRCRelease message) for instructing the network entity to release a connection with an access node (e.g. base station); and releasing the connection in response to receiving the release message, wherein releasing the connection is delayed for a first time period after receiving the release message if the network entity is a User Equipment (UE) and/or if the release message does not include configuration information for configuring a state of the network entity, and wherein releasing the connection is delayed for a second time period, longer than the first time period, after receiving the release message if the network entity is a repeater node (e.g. an NCR) capable of performing a forwarding function in the network and/or if the release message includes configuration information for configuring a state of the network entity.

Certain examples of the present disclosure provide a method, for an access node (e.g. base station) in a network, the method comprising: in response to determining that a release condition is satisfied, transmitting a release message (e.g. an RRCRelease message) for instructing a repeater node (e.g. an NCR), capable of performing a forwarding function in the network, to release a connection with the access node, wherein the release message includes configuration information for configuring a state of the repeater node.

In certain examples, the release condition may be based on one or more of: a quality of coverage provided by the repeater node; a power level of the repeater node; a level of traffic handled by the repeater node; and a level of interference caused by the repeater node.

In certain examples, the release condition is not based on a level of user activity or inactivity.

In certain examples, if the release condition is satisfied, the repeater node is in a connected mode, and the repeater node is in a first state (e.g. a forward-on state), the release message may be transmitted comprising information for transitioning the state of the repeater node to a second state (e.g. a forward-off state).

In certain examples, if a certain condition is satisfied and the repeater node is in a certain first state (e.g. a forward-on state), the configuration information may comprise information for transitioning the state of the repeater node to a certain second state (e.g. a forward-off state).

In certain examples, the certain condition may be based on one or more of: a quality of coverage provided by the repeater node; a power level of the repeater node; an overheating condition of the repeater node; whether a current time falls within a certain predetermined time period (e.g. night time); a level of traffic handled by the repeater node; types of UEs in a cell corresponding to the access node (e.g. base station); and a level of interference caused by the repeater node.

In certain examples, the method may further comprise transmitting, to a core network entity (e.g. an AMF entity), a release indicator message (e.g. a UE Context Release Complete message or a UE Context Release Request) for indicating that release of a network entity has been initiated.

In certain examples, the release indicator message may comprise an indication (e.g. a release cause) that the network entity for which release has been initiated is a repeater node.

In certain examples, the method may further comprise, in response to receiving, from a core network entity (e.g. an AMF entity), a request to release the repeater node, rejecting the request.

In certain examples, the method may further comprise receiving, from another access node (e.g. another base station), a request to release the repeater node, the release condition may be based on receiving the request, and the release message may include information for allowing the repeater node to identify and/or connect to the other access node.

Certain examples of the present disclosure provide a repeater node (e.g. NCR) configured to perform a method according to any example, aspect, embodiment and/or claim disclosed herein.

Certain examples of the present disclosure provide a User Equipment configured to perform a method according to any example, aspect, embodiment and/or claim disclosed herein.

Certain examples of the present disclosure provide an access node (e.g. base station) configured to perform a method according to any example, aspect, embodiment and/or claim disclosed herein.

Certain examples of the present disclosure provide a network (or wireless communication system) comprising a repeater node and an access node according to any example, aspect, embodiment and/or claim disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

When releasing an NCR-MT, it is important that the state of the NCR device is unambiguous. For example, if the NCR-Fwd is turned ON or OFF (e.g. via MAC CEs), then there may be a risk of an ambiguity between the Donor gNB and the NCR. If NCR-Fwd is turned OFF (e.g. via an RRC or higher layer message), then many messages may be required before the NCR can be released. In certain examples, the NCR-Fwd state may be configured in the RRCRelease message. An example of this is illustrated in FIG. 4.

Referring to FIG. 4, in a first operation S401, a gNB 20 may decide that a connection with an NCR 10 should be released.

In a second operation S402, the gNB 20 may transmit a message to the NCR 10 in response to the release decision. In the example of FIG. 4, the message is an RRCRelease message. The message may comprise configuration information for configuring a state (e.g. forwarding state) of the NCR 10. In the example of FIG. 4, configuration information for configuring NCR-Fwd to an OFF state is included in the RRCRelease message. In certain examples, the configuration information may be included in a MAC CE.

In a third operation, S403, the NCR 10 may be configured according to the configuration information (i.e. to an OFF state after previously being in an ON state in the example of FIG. 4).

In a fourth operation S404, the NCR 10 (e.g. an MT part of the NCR 10) may enter idle mode in response to receiving the message. In certain other examples, the NCR 10 may enter an inactive mode in response to receiving the message.

In certain examples, the NCR-Fwd state may be configured using an RRCRelease message according to one or more of the following.

In certain examples, configuration information in the message may explicitly indicate a certain state, among two or more states, to be configured. For example the information may explicitly indicate NCR-Fwd ON or NCR-Fwd OFF.

In certain examples, configuration information in the message may explicitly indicate one certain state to be configured (e.g. NCR-Fwd OFF). In this case, if the information is absent, this may be interpreted as meaning the NCR-Fwd should maintain the current state (i.e. the state before receiving the message).

In certain examples, configuration information in the message may explicitly indicate one certain state to be configured (e.g. NCR-Fwd ON). In this case, if the information is absent, this may be interpreted as meaning the NCR-Fwd should be configured to a complementary state (e.g. NCR-Fwd OFF).

In certain examples, a state to be configured may be implicitly indicated. For example the message may not include any configuration information. In this case, receipt of the message may indicate that a predetermined state (e.g. NCR-Fwd OFF) should be configured.

In certain examples, the configuration information may additionally or alternatively include one or more configuration parameters to apply when the NCR is configured to a certain state (e.g. an NCR-Fwd ON state). For example, the parameters may include information for configuring which beam(s) the NCR shall forward data on. The parameters may be used for configuring Uplink (UL) beams only, configuring Downlink (DL) beams only, or configuring both UL and DL beams. In certain examples, if only UL beams are configured then it may be assumed that existing configuration for DL beams is maintained. Conversely, if only DL beams are configured then it may be assumed that existing configuration for UL beams is maintained. In certain examples, configuration information may include beam-specific configuration information.

In certain examples, when releasing an NCR device, the network may be allowed to control certain operations of the NCR device in various ways. For example, if the NCR may be released when NCR-Fwd is in a certain state (e.g. NCR-Fwd ON), the Donor gNB may configure how long that NCR-Fwd state should be maintained. For example, this may be defined by a time period after receiving the RRCRelease message or after the state is configured. In certain examples, the Donor gNB may configure a delay (e.g. 10 seconds) before the NCR-Fwd state is configured and/or before certain parameters are applied (e.g. reconfiguration of beams). For example, this may be defined by a time period after receiving the RRCRelease message. The aforementioned time period(s) may be defined by (e.g. configurable) timer(s) or may be pre-configured or a set value(s). In certain examples, the time period(s) may be specified by configuration information included in the RRCRelease message.

In certain examples, configuring a time period may include one or more of:
Explicitly configuring an NCR-Fwd state and how long that state shall be maintained
Configuring only a time period defining how long a certain NCR-Fwd state (e.g. NCR-Fwd ON state) shall be maintained
Configuring a certain time period (e.g. defined by a timer). NCR-Fwd will only forward a specific beam for the configured time period. In this example, each configured beam may be associated with a corresponding timer.

In certain examples, a MAC CE used to control NCR-Fwd may be included in the RRCRelease message. This is illustrated in specification example 1 below.

In certain examples, a timer (e.g. T320) may be used to configure how long a set of cell reselection priorities (e.g. configured via RRC Release) are applied by a UE. For an NCR node, these cell reselection priorities may be important to ensure correct NCR idle/inactive operation. In certain examples, if an NCR is configured with cell reselection priorities, the NCR device will turn off its NCR-Fwd if the T320 expires. This is illustrated in specification example 3 below.

In certain examples, the NCR may be configured to stay in RRC idle or inactive mode for a certain time period (e.g. after entering idle or inactive mode) or until a certain time point. For example, the time period or time point may be defined by configuration information in the RRCRelease message. The time period or time point may be independent of other configuration (e.g. the configured NCR-Fwd state in RRCRelease).

At the expiry of the time period or at the time point, the NCR node may be configured to connect to a gNB. For example, this may be the original gNB from which the NCR node was disconnected or a new Donor gNB. This technique improves reachability of the NCR-MT without needing to rely on paging of the NCR-MT. For example, reconnection may be done using any suitable procedure, such as via RRC setup procedure (RRCSetupRequest->RRCSetup->RRCSetupComplete), RRC Reestablishment (RRCReestablishmentRequest->RRCReestablishment->RRCReestablishmentComplete) or RRC Resume (RRCResumeRequest->RRCResume->RRCResumeComplete). In certain examples, a cause (e.g. newly defined cause) for reconnecting may be included in the -Request message.

An example of the above techniques is illustrated in FIG. 5.

Referring to FIG. 5, in a first operation S501, a gNB 20 may decide that a connection with an NCR 10 should be released.

In a second operation S502, the gNB 20 may transmit a message (e.g. RRCRelease message) to the NCR 10 in response to the release decision. The message may comprise configuration information, for example as described above. In the example of FIG. 5, the configuration information includes information for configuring a state (e.g. NCR-Fwd state) of the NCR 10 (e.g. NCR-Fwd OFF) and time information defining a timing for the NCR to attempt reconnection to the gNB 20.

In a third operation, S503, the NCR 10 (e.g. an MT part of the NCR 10) may enter idle mode in response to receiving the message. In certain other examples, the NCR 10 may enter an inactive mode in response to receiving the message. A state of the NCR 10 may also be configured according to the configuration information.

In a fourth operation S504, the NCR 10 may attempt reconnection with the gNB 20 at a time based on the time information. In the example of FIG. 5, the NCR 10 may attempt reconnection a certain time period after entering idle mode, where the time period is specified by the time information.

As an example of how the above techniques may be used, in certain examples the NCR-MT may be released by the Donor gNB despite NCR-Fwd being on, when the gNB has determined that the NCR operating parameters will not change for a relatively long period of time (e.g. a length of time above a certain threshold). For example, this may be determined based on knowledge from NCR operation, for instance that data is being forwarded over the NCR, that UEs are connecting via the NCR and how they are connected via the SSBs. In another example, the gNB may determine, based on coordination with OAM, that the NCR-Fwd (or NCR-MT) will not be reconfigured.

### Applying RRC Release

In various examples, it may be important that there are no mismatches between the NCR and Donor gNB regarding the NCR-Fwd state of the NCR (i.e. whether the NCR is forwarding or not). Accordingly, in certain examples, an acknowledgement procedure may be performed to allow the NCR to acknowledge receipt of the RRCRelease message. For example, an acknowledge procedure may be performed if the RRCRelease message is used to both release the NCR and to configure a state (e.g. NCR-Fwd state) of the NCR. Any suitable acknowledgement procedure may be used. For example NCR may transmit a first acknowledgement message to gNB in response to receiving the RRCRelease message. In certain examples, gNB may transmit a second acknowledgement message to NCR in response to receiving the first acknowledgement message.

In certain examples, configuring the state of the NCR and/or entering idle mode may be delayed at least until a certain time period after receipt of the RRCRelease message. In certain examples, configuring the state of the NCR and/or entering idle mode may be delayed at least until successful completion of the acknowledgement procedure. In certain examples, configuring the state of the NCR and/or entering idle mode may be delayed at least until the earlier of: (i) successful completion of the acknowledgement procedure, and (ii) a certain time period after receipt of the RRCRelease message. Such a delay provides time for successful acknowledgement of the RRCRelease message. For example, the certain time period may be pre-configured or may be defined by configuration information (e.g. in the RRCRelease message).

In certain examples, the time for acknowledgement of the RRCRelease message (e.g. the certain time period referred to above) may be set longer for an NCR device as compared to another type of device (e.g. a UE). In the specification example disclosed further below, certain operations/procedures may be delayed for 1 second in the case of an NCR-MT, or 60 ms otherwise. In certain examples, the NCR may delay certain operations/procedures (e.g. RRC procedures) only if the NCR-Fwd state has been indicated in the RRC release message.

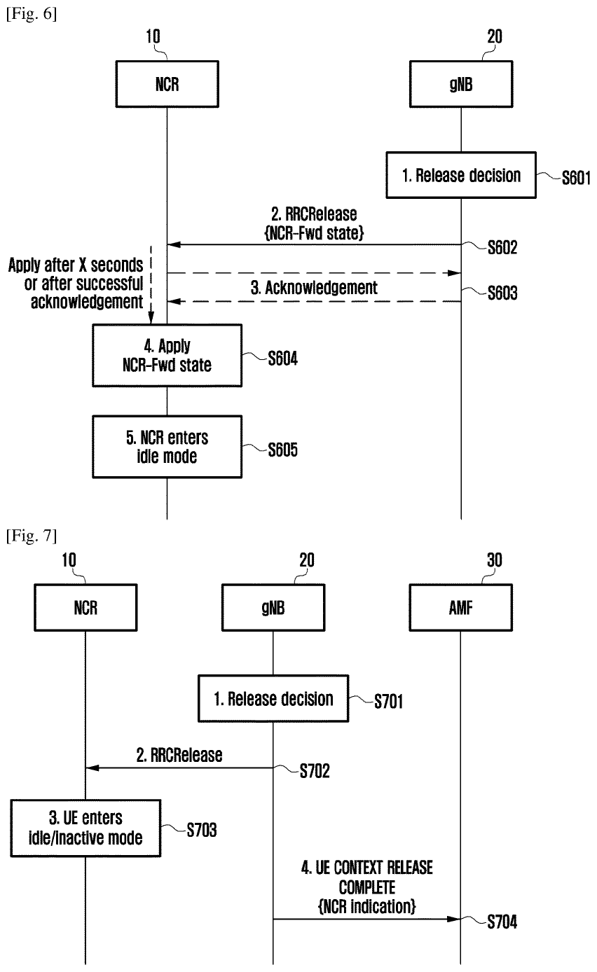

An example of the above techniques is illustrated in FIG. 6.

Referring to FIG. 6, in a first operation S601, a gNB 20 may decide that a connection with an NCR 10 should be released.

In a second operation S602, the gNB 20 may transmit a message (e.g. RRCRelease message) to the NCR 10 in response to the release decision. The message may comprise configuration information, for example as described above. In the example of FIG. 5, the configuration information may include information for configuring an NCR-Fwd state of the NCR 10.

In a third operation S603, an acknowledgement procedure is carried out between the NCR 10 and the gNB 20, in which the NCR 10 acknowledges the RRCRelease message.

In a fourth operation, S604, the NCR 10 may be configured according to the configuration information.

In a fifth operation S605, the NCR 10 (e.g. an MT part of the NCR 10) may enter idle mode (or inactive mode) in response to receiving the RRCRelease message.

The operations S604 and S605 are delayed for a certain time period (e.g. X seconds) after the NCR 10 receives the RRCRelease message or until successful acknowledgement of the RRCRelease message. This delay provides time for successful acknowledgement of the RRCRelease message to reduce the risk of mismatch between the NCR and Donor gNB regarding the NCR-Fwd state of the NCR.

Turning off NCR-Fwd and releasing NCR-MT

In various embodiments any suitable set of one or more conditions or criteria may be used to decide whether to configure a certain state of an NCR, for example to set NCR-Fwd state to OFF. For example, a condition to set a certain state of the NCR (e.g. NCR-Fwd OFF) may be based on one or more of the following.
a quality of coverage provided by the repeater node NCR (e.g. whether the quality of coverage, as measured in any suitable way, falls below a certain threshold). For example, the quality of coverage may be reported, to gNB, by UEs that are connected to it via the NCR. In certain examples, the gNB may query the UEs on the signal quality provided by the NCR-Fwd.
a power level of the NCR (e.g. whether the power level, as measured in any suitable way, is below a certain threshold). For example, the NCR may report its power level to the gNB, either directly or via OAM.
an overheating condition of the NCR (e.g. if the temperature of the NCR is above a certain threshold).
whether a current time falls within a certain predetermined time period (e.g. night time).
a level of traffic handled by the NCR (e.g. whether the traffic level, as measured in any suitable way, falls below a threshold). The traffic level may be based on a cumulative amount of traffic, an average amount of traffic, an amount of traffic within a certain time window, an instantaneous traffic level, etc. The threshold may be configured by the gNB. The threshold may be provided to the NCR via configuration information. The NCR may report the traffic level to the gNB either directly or via OAM.
types of UEs served by a cell corresponding to the gNB. For example, types of UEs may include Machine-Type Communications (MTC) type devices (e.g. devices with relatively small infrequent transmissions), UEs with mostly DL traffic (e.g. devices for which the gNB knows when data arrives), etc. This may make it difficult to match gNB attempting to turn the NCR-Fwd ON/OFF when there is traffic in the cell.
a level of interference caused by the NCR (e.g. whether the interference caused by the NCR is greater than a certain threshold). The interference may be interference experienced by one or more other (neighbouring) network nodes, such as another NCR, a UE, a gNB, etc. The interference may be indicated by the other network nodes.

In certain examples, if the NCR-MT has been released and NCR-Fwd is ON, then the NCR-Fwd may be turned OFF autonomously, for example due to any of the above reasons or any other reasons.

In certain examples, if the NCR-MT is in connected mode and NCR-Fwd is ON, the gNB may initiate release of the NCR-MT and configure NCR-Fwd to OFF. This may be decided based on any suitable set of one or more conditions or criteria. For example, a condition to initiate release of the NCR-MT and configure a certain state of the NCR (e.g. NCR-Fwd OFF) may be based on one or more of the following.
a quality of coverage provided by the repeater node NCR (e.g. whether the quality of coverage, as measured in any suitable way, falls below a certain threshold). For example, the quality of coverage may be reported, to gNB, by UEs that are connected to it via the NCR. In certain examples, the gNB may query the UEs on the signal quality provided by the NCR-Fwd.
a power level of the NCR (e.g. whether the power level, as measured in any suitable way, is below a certain threshold). For example, the NCR may report its power level to the gNB, either directly or via OAM.
a level of traffic handled by the NCR (e.g. whether the traffic level, as measured in any suitable way, falls below a threshold). The traffic level may be based on a cumulative amount of traffic, an average amount of traffic, an amount of traffic within a certain time window, an instantaneous traffic level, etc. The threshold may be configured by the gNB. The threshold may be provided to the NCR via configuration information. The NCR may report the traffic level to the gNB either directly or via OAM.
a level of interference caused by the NCR (e.g. whether the interference caused by the NCR is greater than a certain threshold). The interference may be interference experienced by one or more other (neighbouring) network nodes, such as another NCR, a UE, a gNB, etc. The interference may be indicated by the other network nodes.

### Architecture/Core Network (CN) Aspects

In certain examples, the releasing of an NCR-MT is typically triggered by a gNB, rather than by the Core Network. This is because there is typically no dedicated (own) user downlink data for an NCR device (since it is a repeater node).

In certain examples, the gNB does not need to request permission (e.g. from an AMF) to release an NCR-MT (which is normally needed for a UE). In this case, the gNB may, for example, release the NCR-MT and then send a message (e.g. a UE Context Release Complete message) to the AMF. In certain examples, the message may include a cause or flag indicating to the AMF that the message relates to NCR. In certain examples, the AMF may infer that the message relates to an NCR device by virtue of receiving the message (e.g. a UE Context Release Complete message) without previously having received a release request message. Accordingly, the NCR device may be released without the gNB receiving a UE CONTEXT RELEASE COMMAND, and no flag is needed in the UE Context Release Complete message transmitted to the AMF.

An example of the above technique is illustrated in FIG. 7.

Referring to FIG. 7, in a first operation S701, a gNB 20 may decide that a connection with an NCR 10 should be released. This decision may be made without needing to request permission from an AMF 30. Hence, no message needs to be transmitted to the AMF 30 at this stage. However, in some examples, the gNB may nevertheless send a UE Context Release Request to the AMF 30, for example with an NCR-specific release cause.

In certain examples, the AMF is not allowed to trigger release of an NCR device. In this case, the AMF may not send, for example to a gNB, a request to release an NCR device. In certain examples, if the AMF does attempt to request release of an NCR device, the gNB may refuse the request. For example, the gNB may reject any request message received from the AMF.

In a second operation S702, the gNB 20 may transmit a first message (e.g. RRCRelease message) to the NCR 10 in response to the release decision. In certain examples, the first message may comprise configuration information, for example as described above.

In a third operation S703, the NCR 10 (e.g. an MT part of the NCR 10) may enter idle mode (or inactive mode) in response to receiving the RRCRelease message. In certain examples, an acknowledgement procedure may be carried out, for example as described above. In certain examples the NCR 10 may be configured according to the configuration information, for example as described above.

In a fourth operation S704, the gNB 20 may transmit a second message (e.g. UE Context Release Complete message) to the AMF 30 to indicate to the AMF 30 that the NCR-MT has been released. The second message may include an indicator that the message relates to the NCR 10. In certain examples, the fourth operation S704 may be omitted so that the AMF 30 is not informed when the NCR-MT is released.

In certain examples, a second gNB may request a first gNB to release an NCR device connected to the first gNB. The second gNB may make such a request for any suitable reason, for example due to interference caused by the NCR affecting the second gNB and/or due to a determination that the NCR device should be connected to another gNB, for example the second gNB. For example, this may be useful in cases where connected mode mobility is not supported for NCR-MT, in which case releasing the NCR may be the only, or the easiest, active method of performing mobility.

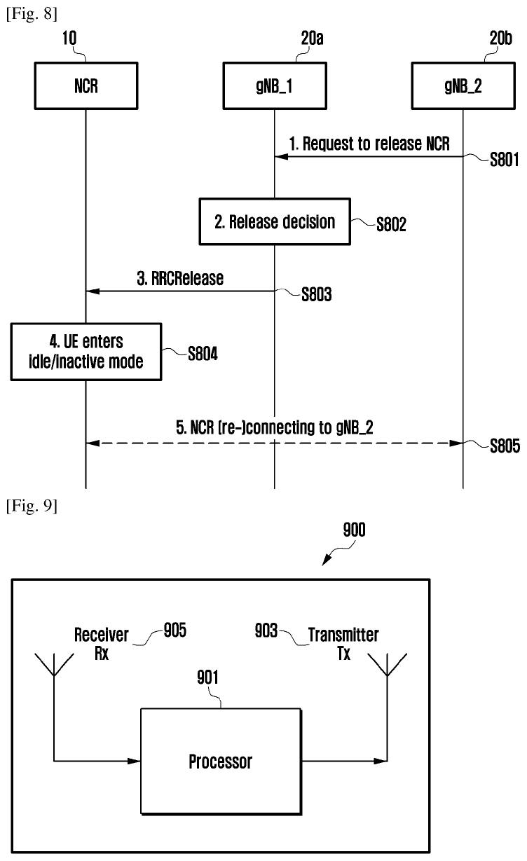

An example of the above technique is illustrated in FIG. 8.

Referring to FIG. 8, in a first operation S801, a first gNB (gNB_1) 20a may receive a request from a second gNB (gNB_2) 20b to release a connection with an NCR 10. In certain examples, the request message may comprise configuration information, for example as described above. The configuration information may include information for allowing the NCR 10 to identify and/or connect to the second gNB 20b.

In a second operation S802, in response to receiving the request, the first gNB 20a may decide that the connection with the NCR 10 should be released.

In a third operation S803, the first gNB 20a may transmit a message (e.g. RRCRelease message) to the NCR 10 in response to the release decision. In certain examples, the message may comprise configuration information, for example as described above. The configuration information may include information for allowing the NCR 10 to identify and/or connect to the second gNB 20b.

In a fourth operation, S804, the NCR 10 (e.g. an MT part of the NCR 10) may enter idle mode (or inactive mode) in response to receiving the message. In certain examples, an acknowledgement procedure may be carried out, for example as described above. In certain examples the NCR 10 may be configured according to the configuration information, for example as described above.

In a fifth operation S805, the NCR 10 may attempt connection with the second gNB 20b. The NCR 10 may use at least part of the configuration information to perform the connection to the second gNB 20b. The timing of the connection attempt may be based on timing information, for example as described above.

In certain examples, no UE context management is performed together with the AMF. F1 Application Protocol (F1AP) context may not be maintained-context management may be performed solely by gNB using the NG Application Protocol (NGAP) UE Context for the NCR-MT.

In certain examples, user inactivity (e.g. determined based on no downlink payload packets having arrived from the User Plane Function (UPF) to be transmitted) is not used, and/or is ignored, as a trigger by the gNB to release an NCR. In certain examples, one or more other triggers, for example as described herein, may be used instead.

In the present disclosure, various examples using NCRs have been described. However, the skilled person will appreciate that the techniques described herein are applicable to any other suitable type of “smart” or “enhanced” repeater node. A smart/enhanced repeater node may be regarded as a repeater node that provides functionality beyond a simple repeat function (e.g. amplifying signals all the time in all directions). For example, such functionality may include beamforming, separate UL and DL modes, and other suitable configurable functionality. The skilled person will appreciate that references herein to “repeater” or “repeater node” include references to such a smart/enhanced repeater node (e.g. NCR), and references herein to “forwarding” or “forwarding function” include references to enhanced forward capabilities of a smart/enhanced repeater node.

In the present disclose, references to releasing a connection with a repeater node (e.g. NCR) may include references to releasing a connection with one more specific functions or entities of the repeater node (e.g. NCR-MT). For example, releasing a connection with the NCR illustrated in FIG. 1 may refer in some cases to releasing the control link, thereby releasing a connection with the NCR-MT. In other cases, releasing a connection with a repeater node may refer to releasing all connections with the repeater node (e.g. both the control link and the backhaul link in FIG. 1).

The skilled person will appreciate that any other suitable configuration information may be used in various examples. For example, NCR-MT state, and especially INACTIVE, may include its own configuration (e.g. a specific DRX, RAN notification area). There may also be aspects of UE behaviour that could be skipped for NCR (in some cases) while in INACTIVE (e.g. transmitting SRS for positioning uses).

Specification example of Example 1: Configure NCR-Fwd in RRC Release is disclosed in Table 2 and Table 3 below.

TABLE 2

------------------------- 3GPP TS 38.331 V17.2.0 -------------------------

```
- RRCRelease
The RRCRelease message is used to command the release of an RRC connection or the suspension
of the RRC connection.
  Signalling radio bearer: SRB1
  RLC-SAP: AM
  Logical channel: DCCH
  Direction: Network to UE
```

RRCRelease message

-- ASN1START
-- TAG-RRCRELEASE-START

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}

| RRCRelease-IEs ::= | SEQUENCE { | |
|---|---|---|
| redirectedCarrierInfo | RedirectedCarrierInfo | OPTIONAL, -- Need N |
| cellReselectionPriorities | CellReselectionPriorities | OPTIONAL, -- Need R |
| suspendConfig | SuspendConfig | OPTIONAL, -- Need R |
| deprioritisationReq | SEQUENCE { | |
| deprioritisationType | ENUMERATED {frequency, nr}, | |
| deprioritisationTimer | ENUMERATED {min5, min10, min15, min30} | |
| } | | OPTIONAL, -- Need N |
| lateNoncriticalExtension | OCTET STRING | OPTIONAL, |
| nonCriticalExtension | RRCRelease-v1540-IEs | OPTIONAL |

}

| RRCRelease-v1540-IEs ::= | SEQUENCE { | |
|---|---|---|
| waitTime | RejectWaitTime | OPTIONAL, -- Need N |
| nonCriticalExtension | RRCRelease-v1610-IEs | OPTIONAL |

}

| RRCRelease-v1610-IEs ::= | SEQUENCE { | |
|---|---|---|
| voiceFallbackIndication-r16 | ENUMERATED {true} | OPTIONAL, -- Need N |

| | |
|---|---|
| measIdleConfig-r16 | SetupRelease {MeasIdleConfigDedicated-r16} |

OPTIONAL, -- Need M

| | | |
|---|---|---|
| nonCriticalExtension | RRCRelease-v1650 IEs | OPTIONAL |

}

| RRCRelease-v1650-IEs ::= | SEQUENCE { | |
|---|---|---|
| mpsPriorityIndication-r16 | ENUMERATED {true} | OPTIONAL, -- Cond |

Redirection2

| | | |
|---|---|---|
| nonCriticalExtension | RRCRelease-v1710-IEs | OPTIONAL |

}

| RRCRelease-v1710-IEs ::= | SEQUENCE { | |
|---|---|---|
| noLastCellUpdate-r17 | ENUMERATED {true} | OPTIONAL, -- Need S |
| nonCriticalExtension | RRCRelease-v1800-IEs | OPTIONAL |

}

| RRCRelease-v1800-IEs ::= | SEQUENCE { | |
|---|---|---|
| ncr-State-r18 | NCR-State-r18 | OPTIONAL, -- Need S |
| nonCriticalExtension | SEQUENCE { } | OPTIONAL |

}

| | <OMITTED> | |
|---|---|---|
| NCR-State-r18 ::= | SEQUENCE { | |
| ncr-FwdOff-r18 | ENUMERATED {true} | OPTIONAL, -- Need S |

| | |
|---|---|
| ncr-ForwardingState-r18 | BIT STRING (SIZE (32)) |

}
-- TAG-RRCRELEASE-STOP
-- ASN1STOP

TABLE 3
RRCRelease-IEs field descriptions

cellReselectionPriorities
Dedicated priorities to be used for cell reselection as specified in TS 38.304 [20]. The maximum number of NR
carrier frequencies that the network can configure through FreqPriorityListNR and
FreqPriorityListDedicatedSlicing together is eight. If the same frequency is configured in both
FreqPriorityListNR and FreqPriorityListDedicatedSlicing, the frequency is only counted once.
cnType
Indicate that the UE is redirected to EPC or 5GC.
deprioritisationReq
Indicates whether the current frequency or RAT is to be de-prioritised.
deprioritisationTimer
Indicates the period for which either the current carrier frequency or NR is deprioritised. Value minN
corresponds to N minutes.
measIdleConfig
Indicates measurement configuration to be stored and used by the UE while in RRC_IDLE or RRC_INACTIVE.
mpsPriorityIndication
Indicates the UE can set the establishment cause to mps-PriorityAccess for a new connection following a
redirect to NR. If the target RAT is E-UTRA, see TS 36. 331 [10]. The gNB sets the indication only for UEs
authorized to receive MPS treatment as indicated by ARP and/or QoS characteristics at the gNB, and it is
applicable only for this instance of release with redirection to carrier/RAT included in the redirectedCarrierInfo
field in the RRCRelease message.
ncr-State
Configures the NCR forwarding state, where the NCR-Fwd may be turned off or configured by ncr-
ForwardingState. If an NCR receives RRCRelease without this field, the NCR-Fwd state is retained when
released.
noLastCellUpdate
Presence of the field indicates that the last used cell for PEI shall not be updated. When the field is absent, the
PEI-capable UE shall update its last used cell with the current cell. The UE shall not update its last used cell
with the current cell if the AS security is not activated.
srs-PosRRC-InactiveConfig
SRS for positioning configuration during RRC_INACTIVE state.
suspendConfig
Indicates configuration for the RRC_INACTIVE state. The network does not configure suspendConfig when the
network redirect the UE to an inter-RAT carrier frequency or if the UE is configured with a DAPS bearer.
redirectedCarrierInfo
Indicates a carrier frequency (downlink for FDD) and is used to redirect the UE to an NR or an inter-RAT carrier
frequency, by means of cell selection at transition to RRC_IDLE or RRC_INACTIVE as specified in TS 38.304
[20]. Based on UE capability, the network may include redirectedCarrierInfo in RRCRelease message with
suspendConfig if this message is sent in response to an RRCResumeRequest or an RRCResumeRequest1
which is triggered by the NAS layer (see 5.3.1.4 in TS 24,501 [23]).
voiceFallbackIndication
Indicates the RRC release is triggered by EPS fallback for IMS voice as specified in TS 23.502 [43].

Specification example of Example 2: Delayed NCR RRC release procedures is disclosed in Table 4 below.

TABLE 4

| | ------------------------- 3GPP TS 38.331 V17.2.0 ------------------------- |
|---|---|
| 5.3.8.3 | Reception of the RRCRelease by the UE |

The UE shall:

| 1> | except for NCR-MT delay the following actions defined in this clause 60 ms from the moment the | |
|---|---|---|
| | RRCRelease message was received or optionally when lower layers indicate that the receipt of the | |
| | RRCRelease message has been successfully acknowledged, whichever is earlier; | |
| 1> | for NCR-MT delay the following actions defined in this clause 1 second from the moment the | |
| | RRCRelease message was received or optionally when lower layers indicate that the receipt of the | |
| | RRCRelease message has been successfully acknowledged, whichever is earlier; | |
| 1> | stop timer T380, if running; | |
| 1> | stop timer T320, if running; | |
| 1> | if timer T316 is running; | |
| | 2> | stop timer T316; |
| | 2> | clear the information included in VarRLF-Report, if any; |

| | |
|---|---|
| 1> | stop timer T350, if running; |

...
------------------------- 3GPP TS 38.331 V17.2.0 -------------------------

Specification example of Example 3: T320 expiry is disclosed in Table 5 below.

TABLE 5

| | ------------------------- 3GPP TS 38.331 V17.2.0 ------------------------- |
|---|---|
| 5.3.8.4 | T320 expiry |

The UE shall:

| 1> | if T320 expires: | |
|---|---|---|
| | 2> | if stored, discard the cell reselection priority information provided by the cellReselectionPriorities |
| | | or inherited from another RAT; |
| | 2> | apply the cell reselection priority information broadcast in the system information. |
| | 2> | for NCR-MT reset the NCR-Fwd state |

------------------------- 3GPP TS 38.331 V17.2.0 -------------------------

FIG. 9 is a block diagram of an exemplary network entity that may be used in examples of the present disclosure. For example, the UE, gNB, AMF, NCR and/or other NFs in the examples of FIGS. 1-8 may be provided in the form of the network entity illustrated in FIG. 9. The skilled person will appreciate that a network entity may be implemented, for example, as a network element on a dedicated hardware, as a software instance running on a dedicated hardware, and/or as a virtualised function instantiated on an appropriate platform (e.g. on a cloud infrastructure).

The entity 900 comprises a processor (or controller) 901, a transmitter 903 and a receiver 905. The receiver 905 is configured for receiving one or more messages from one or more other network entities, for example as described above. The transmitter 903 is configured for transmitting one or more messages to one or more other network entities, for example as described above. The processor 901 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

### ABBREVIATIONS/DEFINITIONS

In the present disclosure, the following acronyms/definitions are used.
3GPP 3^{rd} Generation Partnership Project
5G 5^{th} Generation
5GC 5G Core
AM Acknowledged Mode
AMF Access and Mobility management Function
ARP Allocation and Retention Priority
AS Access Stratum
CE Control Element
CN Core Network
CU Central Unit
DAPS Dual Active Protocol Stack
dBm decibel-milliwatts
DCCH Dedicated Control Channel
DL Downlink
DU Distributed Unit
eNB Base Station
EN-DC E-UTRA NR Dual Connectivity
EPC Evolved Packet Core
EPS Evolved Packet System
E-UTRA Evolved Universal Terrestrial Radio Access
E-UTRAN Evolved Universal Terrestrial Radio Access Network
F1 Interface between gNB-CU and gNB-DU
F1AP F1 Application Protocol
FDD Frequency Division Duplex
FFS For Further Study
Fwd Forward
gNB 5G NR Base Station
IAB Integrated Access and Backhaul
IE Information Element
IoT Internet of Things
IMS IP Multimedia Subsystem
IP Internet Protocol
LTE Long Term Evolution
LTE-M LTE Machine Type Communication
MAC Medium Access Control
MME Mobility Management Entity
MPS Multimedia Priority Service
ms Millisecond
MT Mobile Termination
MTC Machine-Type Communications
NAS Non Access Stratum
NB Narrowband
NB Base Station
NCR Network-Controlled Repeater
NG Next Generation
NGAP NG Application Protocol
NR New Radio
OAM Operations, Administration and Maintenance
PEI Permanent Equipment Identifier
QoS Quality of Service
RLC Radio Link Control
PLMN Public Land Mobile Network
RAN Radio Access Network
RAT Radio Access Technology
RF Radio Frequency
RLF Radio Link Failure
RNA RAN Notification Area
RRC Radio Resource Control
RSRP Reference Signal Received Power
S1 Interface between RAN and CN
SA Stand-Alone
SAP Service Access Point
SDT Short Data transmissions
SRB Signalling Radio Bearer
SRS Sounding Reference Signal
SSB Synchronization Signal Block
TAG Timing Advance Group
TAU Tracking Area Update
TS Technical Specification
Txxx Timer xxx
UE User Equipment
UL Uplink
UPF User Plane Function
X2/Xn Interface between RAN nodes

1. A method performed by a terminal, the method comprising:
receiving, from a base station, a message for a radio resource control (RRC) release;
performing a transition of an RRC state of the terminal from an RRC connected state to an RRC idle state, based on the message for the RRC release; and
configuring a state of a network-controlled repeater (NCR) forward (NCR-fwd) as a forwarding-off state based on the message for the RRC release, in case that the terminal comprises an NCR mobile termination (MT).

2. The method of claim 1, wherein time information for a transition of the RRC state included in the message for the RRC release.

3. The method of claim 2, further comprising:
performing the transition of the RRC state of the terminal from the RRC idle state to the RRC connected state, based on the time information in case that the terminal comprises the NCR MT.

4. The method of claim 1, further comprising:
receiving, from the base station, a message including information on a NCR-fwd configuration; and
identifying whether information on a periodic forwarding resource configuration is included in the information on the NCR-fwd configuration,
wherein data is continuously forwarded by the NCR-fwd based on the information on the periodic forwarding resource configuration.

5. A method performed by a base station, the method comprising:
transmitting, to a terminal, a message for a radio resource control (RRC) release,
wherein a transition of an RRC state of the terminal is performed from an RRC connected state to an RRC idle state, based on the message for the RRC release, and
wherein a state of a network-controlled repeater (NCR) forward (NCR-fwd) is configured as a forwarding-off state based on the message for the RRC release, in case that the terminal comprises an NCR mobile termination (MT).

6. The method of claim 5, wherein time information for a transition of the RRC state included in the message for the RRC release.

7. The method of claim 6, wherein the transition of the RRC state of the terminal is performed from the RRC idle state to the RRC connected state, based on the time information in case that the terminal comprises the NCR MT.

8. A terminal, comprising:
a transceiver; and
at least one processor is configured to:
receive, from a base station via the transceiver, a message for a radio resource control (RRC) release,
perform a transition of an RRC state of the terminal from an RRC connected state to an RRC idle state, based on the message for the RRC release, and
configure a state of a network-controlled repeater (NCR) forward (NCR-fwd) as a forwarding-off state based on the message for the RRC release, in case that the terminal comprises an NCR mobile termination (MT).

9. The terminal of claim 8, wherein time information for a transition of the RRC state included in the message for the RRC release.

10. The terminal of claim 9, wherein the at least one processor is further configured to:
perform the transition of the RRC state of the terminal from the RRC idle state to the RRC connected state, based on the time information in case that the terminal comprises the NCR MT.

11. The terminal of claim 8, wherein the at least one processor is further configured to:
receive, from the base station via the transceiver, a message including information on a NCR-fwd configuration, and
identify whether information on a periodic forwarding resource configuration is included in the information on the NCR-fwd configuration,
wherein data is continuously forwarded by the NCR-fwd based on the information on the periodic forwarding resource configuration.

12. A base station, comprising:
a transceiver; and
at least one processor is configured to:
transmit, to a terminal via the transceiver, a message for a radio resource control (RRC) release,
wherein a transition of an RRC state of the terminal is performed from an RRC connected state to an RRC idle state, based on the message for the RRC release, and
wherein a state of a network-controlled repeater (NCR) forward (NCR-fwd) is configured as a forwarding-off state based on the message for the RRC release, in case that the terminal comprises an NCR mobile termination (MT).

13. The base station of claim 12, wherein time information for a transition of the RRC state included in the message for the RRC release.

14. The base station of claim 13, wherein the transition of the RRC state of the terminal is performed from the RRC idle state to the RRC connected state, based on the time information in case that the terminal comprises the NCR MT.
